(19) United States
(12) Patent Application Publication
(10) Pub. No.: US 2021/0149545 A1
(43) Pub. Date: May 20, 2021

(54) SYSTEMS FOR NAVIGATING A THREE-DIMENSIONAL MODEL WITH A HANDHELD CONTROLLER

(71) Applicant: SELLEN CONSTRUCTION CO., INC., Seattle, WA (US)

(72) Inventor: Andrew G. Struthers, Seattle, WA (US)

(73) Assignee: SELLEN CONSTRUCTION CO., INC.

(21) Appl. No.: 17/097,866

(22) Filed: Nov. 13, 2020

Related U.S. Application Data
(60) Provisional application No. 62/936,266, filed on Nov. 15, 2019.

(51) Int. Cl. G06F 3/0481; G06F 3/0482; G06F 9/445; G06F 30/13; G06F 30/12; G06T 17/00

(52) U.S. Cl. CPC G06F 3/04815; G06F 3/0482; G06F 9/44526; G06F 2111/16; G06F 30/12; G06T 17/00; G06F 30/13

(57) ABSTRACT

Techniques for creating a layout for a handheld controller and navigating a virtual three-dimension space of a three-dimensional modeling application are disclosed herein. In some examples, the techniques may include navigating a building information management (BMI) application with the handheld controller based on the layout. In some examples, a computing device may render a graphical user interface (GUI), which may be generated by executing the three-dimensional modeling application and/or various application plug-ins for the three-dimensional modeling application. For instance, the plug-ins may comprise an activating a layout plug-in, a customizing the layout plug-in, and/or a viewing a current layout plug-in. In some examples, the system may present one or more interactive GUI elements, such as drop down menus for assigning model navigation commands to one or more actuators of the handheld controller, to create and store the layout.

### CROSS-REFERENCE TO RELATED APPLICATIONS

This application claims priority to, and the benefit of, U.S. Provisional Patent Application No. 62/936,266, filed Nov. 15, 2019 and entitled “Systems for Navigating a Three-Dimensional Model with a Handheld Controller,” which is incorporated herein by reference in its entirety.

### BACKGROUND

Autodesk® Navisworks is a powerful tool that allows users to navigate three-dimensional models. However, this software is underutilized due to the cumbersome default camera movement and rotation tools built into Navisworks. Other industrial/commercial three-dimensional modeling applications face similar usability issues resulting in inefficient use of computing resources and personnel time.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. Reference numbers may be omitted from similar or identical terms without intending to suggest a distinction between the terms.

FIG. 1 depicts a schematic diagram of an example system for navigating a three-dimensional model with a handheld controller based on a layout of the handheld controller.

FIG. 2 depicts a flow diagram of an example method for activating the layout of handheld controller, which may be performed by any of the systems discussed herein.

FIG. 3. depicts a flow diagram of an example method for customizing the layout of the handheld controller, which may be performed by any of the systems discussed herein.

FIG. 4. depicts a flow diagram of an example method for viewing a current layout of the handheld controller, which may be performed by any of the systems discussed herein.

FIG. 5 depicts a flow diagram of an example method for navigating a three-dimensional model with a handheld controller, which may be performed by any of the systems discussed herein.

### DETAILED DESCRIPTION

### Overview

Systems, methods, and apparatuses (hereinafter the “system”) disclosed herein may include a handheld controller and operations for communicating with modeling software or three-dimensional modeling applications such as building information modeling (BIM) applications (e.g., BIM checking applications and/or BIM viewing applications, such as the Autodesk® Navisworks®, Simulate®, Solibri Model Checker, BIMcollab®, Simplebim®, BIM Assure®, Revizto®, and/or BIM Track® application, or other modeling software (e.g., for construction modeling, engineering, etc.), such that a user may control the software with the handheld controller. The handheld controller may, in some examples, comprise a standardized gaming console such as an Xbox One® controller, a PlayStation® controller, a Nintendo Switch® controller, and/or other types of gaming console controllers.

In some instances, the system may create the basic camera movement and rotation functionality most first-person video games use, which may provide a sense of familiarity for any user who has played video games before. The system may include additional advanced functionalities that help the user directly interact with the 3D model, all through the handheld controller (e.g., the Xbox One® controller, the PlayStation® controller, the Nintendo Switch® controller, and/or the other types of gaming console controllers).

In some instances, users of a three-dimensional modeling application may no longer have to spend an unnecessary amount of time figuring out how to precisely move through the three-dimensional models. Instead, they may just pick up familiar type of handheld controller (e.g., the Xbox One® controller, the PlayStation® controller, the Nintendo Switch® controller, and/or the other types of gaming console controllers) and start navigating with ease. In some instances, the systems disclosed herein provides a higher accuracy when working on a building, which may provide a better understanding of what each person in the field is working on. There may be a greater depth of understanding between the 2D drawings on paper and the finished product if everyone in the field can easily access and work with the intermediary 3D models. Everyone having a better understanding of what they are doing may, in some examples, lead to fewer errors in the field and more efficient building practices, which may help the company reduce costs and increase efficiencies.

In some examples, picking up gaming console controller and flying through a model is fun. Making three-dimensional modeling software feel more like a video game may, in some instances, get more people to engage with the models more. People are often worried they will somehow mess something up or break the model, but if navigating through it feels more like a video game, people may be more comfortable with using Navisworks.

In some examples, the system may include a Microsoft Xbox One controller, Autodesk® Navisworks Manage or Simulate 2017 through 2020. The system may include Autodesk® products and versions.

The systems, devices, and techniques described herein can improve the computing device executing the third-party application by providing a more efficient tool for receiving user inputs. By reducing unnecessary and/or less efficient user inputs, the systems, devices, and techniques may optimize the computing resources (e.g., by lowering the CPU requirements) need for executing the third-party application. may help These and other improvements to the functioning of a computer and network are discussed herein.

### Model Navigation Commands

In some examples, the system may include one or more commands (“model navigation commands”) for navigating the three-dimensional model and/or the graphical user interface (GUI) of the three-dimensional model. The one or more model navigation commands may be assigned to one or more actuators of the handheld controller such as a particular button, a particular elapsed button hold time, a particular joy stick motion, a particular joy sick click, and/or combinations thereof. The model navigation commands may include, but is not limited to:
Left Mouse Click
   This may simulate a generic mouse left click. In some instances, this command may not support holding left click down, it simply presses left click then releases.
Right Mouse Click
   This may simulate a generic mouse right click, bringing up the appropriate right click menu, which may be no different than a mouse would.
Multi Select
   This may allow the user to click on more than one object at one time.
Clear
   This may clear the currently selected object(s) within Navisworks.
Display Controller Layout
   This may display the current controller layout the user is currently using.
Exit
   This may exit the controller plugin and/or may vibrate the controller to indicate to the user the plugin exiting.
Elevation Up
   This may move the camera directly up.
Elevation Down
   This may move the camera directly down.
Mouse Left
   This may activate control of the mouse by the left joystick.
Mouse Right
   This may activate control of the mouse by the right joystick.
Properties Menu
   This may bring up the properties menu for the current selected object.
Selection Tree
   This may bring up the built in selection tree for the current drawing, allowing the user to view the different sub-drawings used to create the overall model.
Print Current Screen
   This may bring up the built in print menu and may give the user the option to print the current view to their choice of printer.

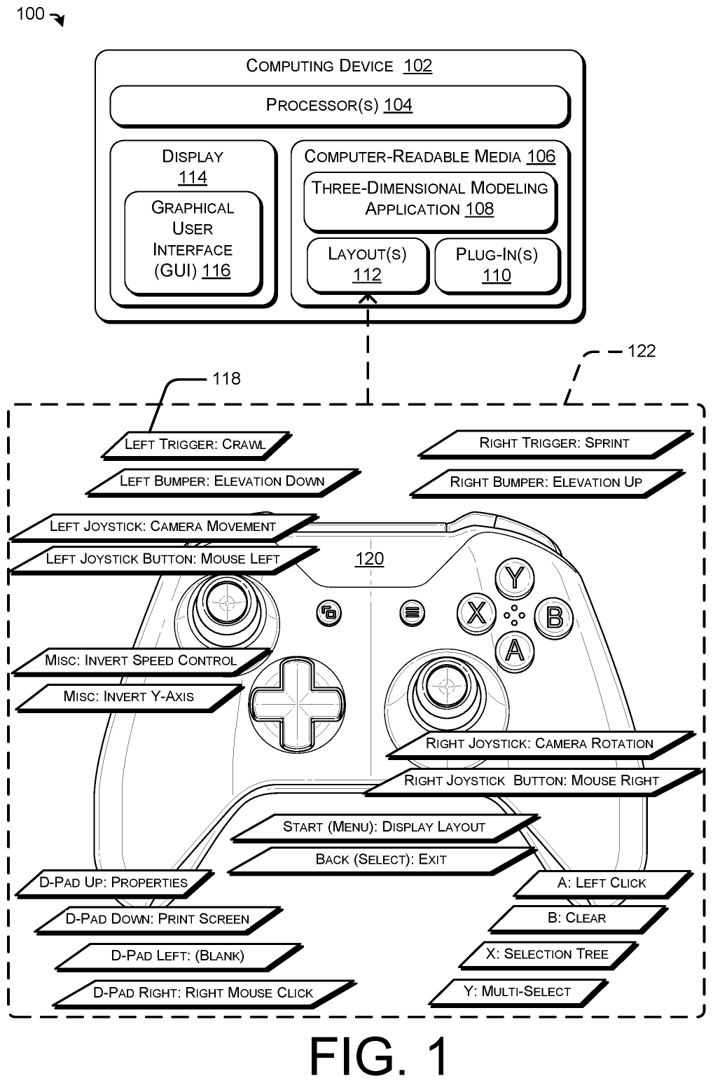

FIG. 1 illustrates an example system 100 which may be similar to, identical to, or form a part of any of the systems discussed herein. The system 100 may comprise a computing device 102 including one or more processor(s) 104 and computer-readable media 106 (e.g., databases) for storing a three-dimensional modeling application 108, one or more plug-ins 110, and a layout(s) database 112. The computing device 102 may comprise a display 114 for rendering a GUI 116 (e.g., generated by executing the three-dimensional modeling application 108 and/or the 110 plug-ins). In some instances, the GUI 116 may comprise one or more interactive GUI elements such as drop down menus 118 corresponding to one or more actuators of a handheld controller 120. For instance, selecting a particular model navigation command at a particular drop down menu 118 may assign the particular model navigation command to a particular actuator corresponding to the particular drop down menu 118. In some instances, one or more (e.g., a plurality) of assignments of model navigation commands to actuators may be stored as a particular layout 122 in the layout(s) database 112. FIG. 1 illustrates multiple particular assignments (e.g., left trigger: crawl; left bumper: elevation down, etc.) of the particular layout 122.

In some examples, the one or more processor(s) 104 may comprise one or more of a microprocessor, a microcomputer, a microcontroller, a digital signal processor, a central processing unit (CPU), a graphics processing unit (GPU), or combinations thereof, etc. Among other capabilities, the one or more processor(s) 104 may operate to fetch and execute computer-readable instructions stored in computer-readable media 106 to perform the operations disclosed herein.

In some examples, the computer-readable media 106 may comprise one or more non-transitory storage devices such as phase change memory (PCM), static random-access memory (SRAM), dynamic random-access memory (DRAM), other types of random access memory (RAM), read only memory (ROM), electrically erasable programmable ROM (EEPROM), flash memory or other memory technology, compact disc ROM (CD-ROM), field-programmable gate arrays (FPGA), digital versatile discs (DVD) or other optical storage, magnetic cassettes, magnetic tape, magnetic disk storage or other magnetic storage devices, other medium that can be used to store information in one or more databases for access by an electronic device, or combinations thereof.

### Plug-Ins

In some examples, the system 100 may comprise one or more plug-ins. The one or more plug-ins may comprise plug-ins for activating the handheld controller, customizing the handheld controller, and/or viewing a current layout of the controller. The plug-ins are discussed in further detail below.

### Activating the Handheld Controller Plug-in

In some instances, to activate the handheld controller (e.g., the Xbox® controller), a user may open the modeling software (e.g., Autodesk® Navisworks Manage or Simulate) with a valid drawing. The user may navigate to an\ “Tools Add-Ins 1” tab, and click the plug-in associated with the handheld controller (e.g., from a list of multiple different types of handheld controllers or gaming console controllers) which, in some instances, may be titled “Activate [identifier] Controller.” In some examples, if a handheld controller is coupled to a controller port (e.g., plugged in), the user may be able to select the controller configuration they would like to use, then the controller may vibrate. In some instances, a particular layout may be stored in a layouts database associated with a particular controller and/or a particular type of controller. In some instances, the system may determine the particular controller and/or the particular type of controller and determine a corresponding layout based on stored associations. After the controller vibrates, the user may be able to use the handheld controller to move around the three-dimensional model. The user may also have access to all of the commands through various buttons on the controller. Some example commands are left click, elevation up, elevation down, and display controller layout. Additional commands are discussed above.

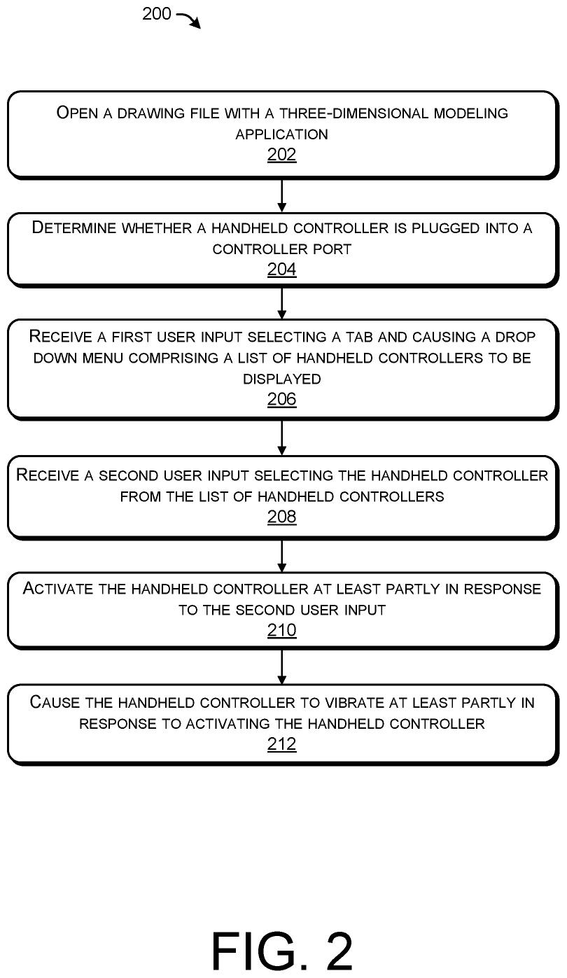

FIG. 2 illustrates an example method 200 for activating a handheld controller plug-in, which may be performed by any of the systems discussed herein. Although steps of the method 200 may be performed by any of the systems disclosed herein, the steps are described as being performed by the system 100 for brevity sake. At step 202, the system 100 may open a drawing file with the three-dimensional modeling application, such as a valid drawing (e.g., a properly formatted drawing file for the particular three-dimensional modeling software). At step 204, the system 100 may determine whether the handheld controller is coupled to (e.g., plugged into) a controller port. At step 206, the system 100 may receive a first input selecting a tab and causing a drop down menu comprising a list of handheld controllers to be displayed. The list of handheld controllers may include the handheld controller based at least in part on the handheld controller being plugged into the controller port. At step 208, the system 100 receive a second user input selecting the handheld controller from the list of handheld controllers. At step 210, the system 100 may activate the handheld controller a least partly in response to the second user input. At step 212, the system 100 may cause the handheld controller to vibrate at least partly in response to activating the handheld controller.

### Customizing a Layout Handheld Controller Layout Plug-In

In some instances, to build a custom handheld controller layout, a user may open the modeling software (e.g., Navisworks Manage or Simulate) and navigate to the “Tools Add-Ins 1” tab. The user may click on an icon associated with customizing the controller layout which, in some examples, may be labelled “Make Custom Controller Layout.” Clicking this icon may generate a screen with different drop down menus or drop boxes. The user may load existing layouts to modify and/or save as new, or the user may start from a completely blank slate and create their own layout from the ground up. By clicking on each drop down menu, the user may be able to select what command they want mapped to the respective button. The user may save their handheld controller layout under a unique name as long as the name follows a few rules. In some instances, the name cannot be “DefaultConfig,” as the system may not allow the user to override the default configuration. The user may type “.txt” at the end of the name, but, in some examples, this may not be required, as the system may add the extension for the user if needed. An example rule may require that no name can have a period except for the period in the extension. Examples of valid names may be names such as “9thAndThomasLayout” or “Yale&Harrison.txt.” Examples of invalid names may be names such as “DefaultConfig.txt” or “Denny.Amazon.Config.txt.”

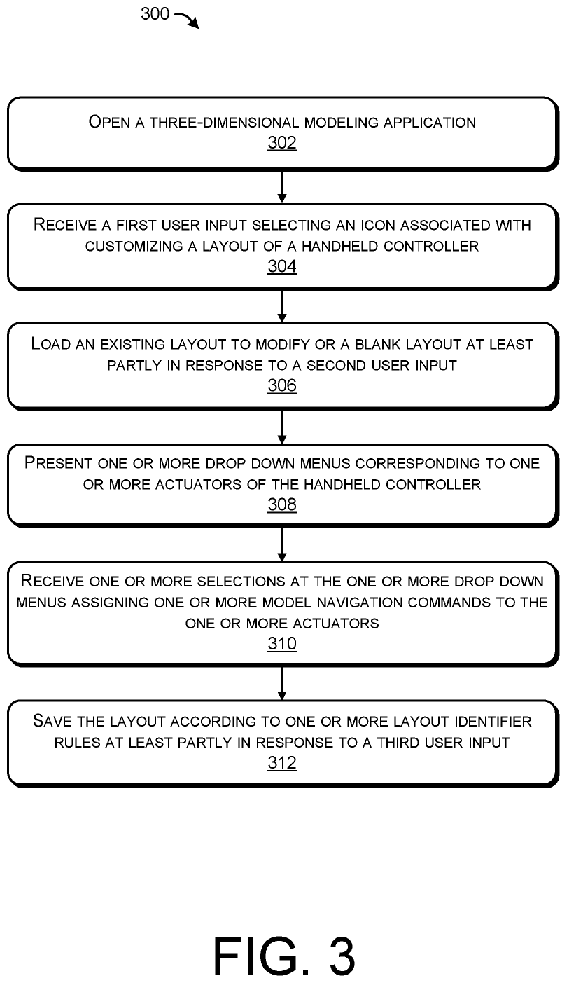

FIG. 3 illustrates an example method 300 for customizing a plug-in for the layout of the handheld controller, which may be performed by any of the systems discussed herein. Although steps of the method 300 may be performed by any of the systems disclosed herein, the steps are described as being performed by the system 100 for brevity sake. At step 302, the system 100 may open the three-dimensional modeling application. At step 304, the system 100 may receive a first user input selecting an icon associated with customizing a layout. At step 306, the system 100 may load an existing layout to modify or a blank layout in response to a second user input. At step 308, the system 100 may present one or more drop down menus corresponding to one or more actuators of the handheld controller. At step 310, the system 100 may receive one or more selections at the one or more drop down menus assigning one or more model navigation commands to the one or more actuators. At step 312, the system 100 may save the layout according to one or more layout identifier rules in response to a third user input.

### Viewing A Current Handheld Controller Layout Plug-In

In some examples, a user may, in the modeling software (e.g., Navisworks), navigate to a “Tool Add-Ins 1” tab and click an icon associated with displaying a current handheld controller layout, which, in some examples, may be labeled “Display Current Controls.” Additionally or alternatively, the same functionality may be achieved if the user clicks a “Display Layout” button on the handheld controller. In some instances, the default for this button may be Start. If no file is open, or no configuration file is selected yet, this plugin may display the default handheld controller layout. An example particular handheld controller layout 124 is illustrated in FIG. 1.

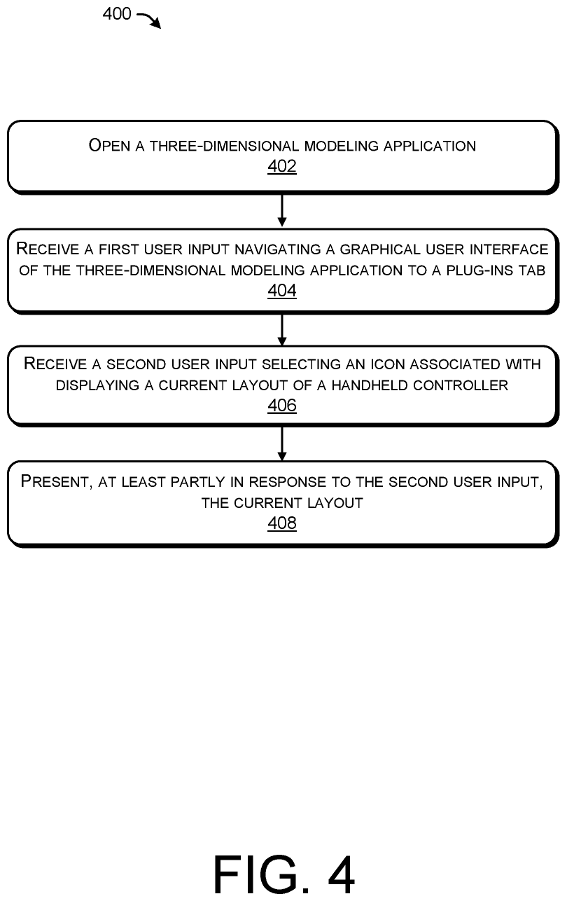

FIG. 4 illustrates an example method 400 for viewing a current handheld controller layout plug-in, which may be performed by any of the systems discussed herein. Although steps of the method 400 may be performed by any of the systems disclosed herein, the steps are described as being performed by the system 100 for brevity sake. At step 402, the system 100 may open the three-dimensional modeling application (e.g., Navisworks). At step 404, the system 100 may receive a first user input navigating the GUI of the three-dimensional modeling application to a plug-ins tab. At step 406, the system 100 may receive a second user input selecting an icon associated with displaying a current layout of the handheld controller. At step 408, the system may present, in response to the second user input, the current layout.

Navigating the Three-Dimensional Model with the Handheld Controller

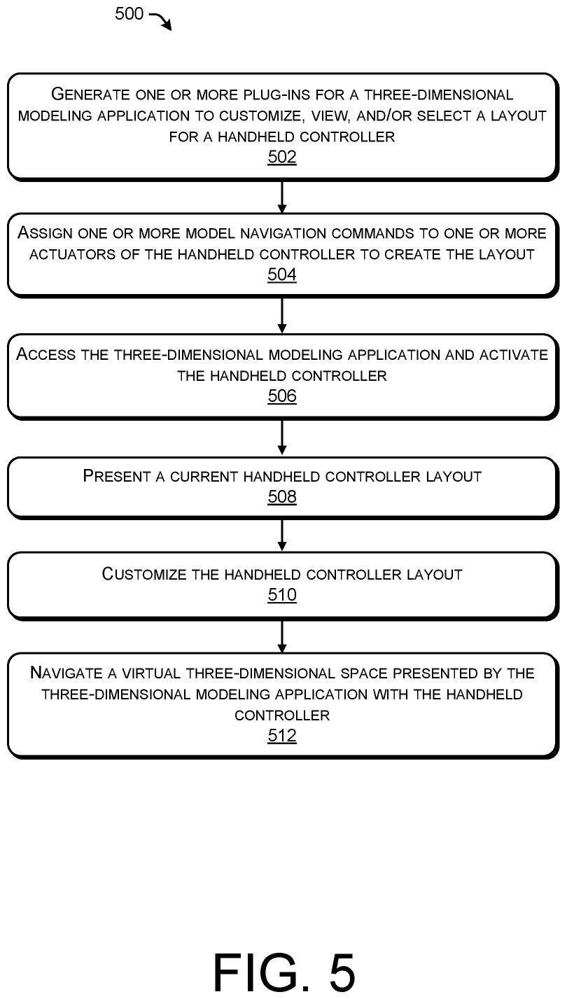

FIG. 5 illustrates an example method 500 that may be performed by any of the systems discussed herein. Although steps of the method 400 may be performed by any of the systems disclosed herein, the steps are described as being performed by the system 100 for brevity sake. The method of FIG. 5 includes operations for navigating the three-dimensional model with the handheld controller as well as interacting with the three-dimensional modeling application (e.g., by assigning a right mouse click, a left mouse click, mimicking a mouse or GUI input device, and/or providing other GUI navigation functions). In some instances, at step 502, the system 100 may generate one or more plug-ins for the three-dimensional modeling application (e.g., Navisworks) to customize, view, and/or select a layout of a handheld controller. At step 504, the system 100 may assign one or more model navigation commands to one or more actuators of the handheld controller to form the layout. At step 506, the system 100 may access the three-dimensional modeling application (e.g., opening the modeling software, loading the modeling software, etc.) and activate the handheld controller, for instance, via the “Tools Add-Ins 1.” At step 508, the system 100 may present the current handheld layout, for instance, via the “Tool Add-Ins 1” tab and/or in response to receiving a selection or click at the icon associated with displaying the current handheld controller layout. At step 510, the system 100 may customize the handheld controller layout, for instance, via “Tools Add-Ins 1” tab and clicking the icon associated with customizing the controller layout. At step 512, the system 100 may navigate a virtual three-dimensional space presented by the three-dimensional modeling application with the handheld controller, for instance, by actuating the one or more actuators of the handheld controller and activating the model navigation commands corresponding to the one or more actuators according to the layout.

Although FIGS. 2-5 illustrate example steps, the described steps in these figures (and all other methods, techniques, and operations disclosed herein) may be performed in other orders different than those illustrated in FIGS. 2-5, and multiple steps may be performed simultaneously or in parallel. Furthermore, in some embodiments, one or more steps illustrated in 2-5 may be omitted, repeated, and/or combined with any other steps illustrated in FIGS. 2-5 or any other operations and components discussed in this disclosure. Any steps illustrated in FIGS. 2-5 may be performed at least partly in response to any of the steps illustrated in FIGS. 2-5.

### Example Computing Architecture and Programming Language

In some examples, software or algorithm components of the systems discussed herein may be developed using a primary programming language, such as C#, and may be built using a code editor, such as Visual Studio 2019. The code may be hosted on a server device, private server and/or at a shared library, such as a private Github repository with ownership or security credentials assigned to one or more users. In some examples, a class library may be packaged in one Dynamic Linking Library (DLL). The system may comprise or communicate with one or more of: SharpDX, SharpDX.XInput, Autodesk.Navisworks.Api, Autodesk.Navisworks.ComApi Autodesk.Navisworks.Interop.ComApi

In some examples, to make any edits to the software, the user may clone the repository from Github, assuming the user has the correct collaborator rights. The software file for implementing the system discussed herein may be stored in a main directory and may be opened by Visual Studio.

In some examples, after making changes to the code and building, SELN.XBoxControllerApp.dll may be stored in \PluginTest\bin\Debug\. A user may copy that DLL to %ProgramData% \Autodesk\ApplicationPlugins\ SELN.XBoxControllerApp.bundle\Contents\ and put the DLL into the folder corresponding with the modeling software version (e.g., the Navisworks year) being targeted.

In some examples, in order to build for a new version of the three-dimensional modeling software (e.g., Navisworks), the user may remove each of the following dependencies from the references list in Project Explorer: Autodesk.Navisworks.Api.dll; Autodesk.Navisworks.ComApi.dll; Autodesk.Navisworks.Interop.ComApi.dll

Then, in order to build, the user may, in some instances, add those three files back to the project from the folder of the version for which the user is building. For examples, if the user builds for Navisworks 2020, the user may add reference to \Autodesk\Navisworks Manage 2020\Autodesk.Navisworks.Api.dll, etc. Once the build is complete, the user may follow the above instructions for copying the DLL into the correct folder. Additionally, if the user is building for a new version of Navisworks, the user may need to create the folder for the new year and add a section in the \PackageContents.xml sheet. The user may copy one of the <Component Description> sections and change the relevant information to point to your new version. For instance, component descriptions for different versions of Navisworks may be as follows:
Navisworks 2020=Nw17
Navisworks 2019=Nw16
Navisworks 2018=Nw15
Navisworks 2017=Nw14

### Example Implementations

Example implementations of the systems (e.g., system 100), methods (e.g., methods 200-500), and devices discussed herein are discussed below.

In some examples, a system may comprise one or more processors; and one or more non-transitory computer-readable storage media storing instructions that, when executed by the one or more processors, cause the system to: receive, at a graphical user interface (GUI), a first user input selecting a drop down menu presented by a three-dimensional modeling application; receive, at the GUI, a second user input selecting a plug-in from the drop down menu; assign, at least partly in response to the second user input, one or more modeling navigation commands to one or more actuators of a handheld controller to create a layout for the handheld controller; open a drawing file with the three-dimensional modeling application to render a virtual three-dimensional space; receive, at the GUI, a third user input selecting the handheld controller for activation; and navigate the virtual three-dimensional space with the one or more actuators of the handheld controller.

In some examples, the one or more actuators comprise a left-thumb stick, a right-thumb stick, a left bumper, a right bumper, a left trigger, a right trigger, and a plurality of buttons.

In some examples, the three-dimensional modeling application comprises a building information management (BIM) application.

In some examples, the one or more modeling navigation commands comprise one or more of a simulated left-mouse click, a simulated right-mouse click, select multiple objects, clear object selection, display a current layout of the handheld controller, activate mouse, display a menu of properties associated with a selected object, display a selection tree indicating sub-drawings related to the drawing file, print a current screen, crawl, sprint, elevation up, elevation down, camera movement, invert speed control, invert y-axis, display properties, clear, or exit.

In some examples, the system may determine that the handheld controller is coupled to a controller port; and present, at least partly in response to the second user input and the handheld controller being coupled to the controller port, a controller identifier indicating that the handheld controller is available for selection.

In some examples, the system may receive a selection of the controller identifier from a list of controller identifiers and, at least partly in response to the selection of the controller identifier, cause the handheld controller to vibrate.

In some examples, the system may save the layout associated with a layout identifier based on one or more layout identifier rules comprising: prohibiting the layout identifier from comprising a ‘DefaultConfig’ string; prohibiting a period punctuation mark in the layout identifier; or including a .txt suffix in the layout identifier.

In some examples, a method may comprise receiving one or more user inputs at a graphical user interface (GUI) of a three-dimensional modeling application; assigning, at least partly in response to the one or more user inputs, one or more modeling navigation commands to one or more actuators of a handheld controller to create a layout for the handheld controller; opening a drawing file with the three-dimensional modeling application to render a virtual three-dimensional space at the GUI; receiving, at least partly in response to the one or more user inputs, a selection of the handheld controller for activation from a menu of the three-dimensional modeling application; activating the handheld controller based at least partly on the selection; and navigating the virtual three-dimensional space with the one or more actuators of the handheld controller based on the layout.

In some examples, the method may comprise determining that the handheld controller is coupled to a controller port; and presenting, at least partly in response to second user input and the handheld controller being coupled to the controller port, a controller identifier indicating the handheld controller is available for selection.

In some examples, the method may comprise receiving a selection of the controller identifier from a list of controller identifiers and, at least partly in response to the selection of the controller identifier, causing the handheld controller to vibrate.

In some examples, the method may comprise saving the layout associated with a layout identifier based on one or more layout identifier rules comprising: prohibiting the layout identifier from comprising a ‘DefaultConfig’ string; prohibiting a period punctuation mark in the layout identifier; or including a .txt suffix in the layout identifier.

In some examples, a device may comprise: a display; one or more processors; and one or more non-transitory computer-readable media storing instructions that, when executed, cause the device to: open a drawing file with a three-dimensional modeling application to render a virtual three-dimensional space; receive, at a graphical user interface (GUI) presented at the display, a first user input selecting a drop down menu of the three-dimensional modeling application; receive, at the GUI, a second user input selecting a handheld controller from a list of handheld controllers for activation from the drop down menu; activate the handheld controller in response to the second user input; and navigate the virtual three-dimensional space with the handheld controller and based on a layout of the handheld controller, the layout comprising one or more assignments of actuators of the handheld controller to modeling navigation commands.

In some examples, the device may determine that the handheld controller is coupled to a controller port; and present, at least partly in response to the second user input and the handheld controller being coupled to the controller port, a controller identifier indicating that the handheld controller is available for selection.

In some examples, the device may receive a selection of the controller identifier from a list of controller identifiers and, at least partly in response to the selection of the controller identifier, cause the handheld controller to vibrate.

### CONCLUSION

Although this disclosure uses language specific to structural features and/or methodological acts, it is to be understood that the scope of the disclosure is not necessarily limited to the specific features or acts described. Rather, the specific features and acts are disclosed as illustrative forms of implementation.

What is claimed is:

1. A system comprising:
one or more processors; and
one or more non-transitory computer-readable storage media storing instructions that, when executed by the one or more processors, cause the system to:
receive, at a graphical user interface (GUI), a first user input selecting a drop down menu presented by a three-dimensional modeling application;
receive, at the GUI, a second user input selecting a plug-in from the drop down menu;
assign, at least partly in response to the second user input, one or more modeling navigation commands to one or more actuators of a handheld controller to create a layout for the handheld controller;
open a drawing file with the three-dimensional modeling application to render a virtual three-dimensional space;
receive, at the GUI, a third user input selecting the handheld controller for activation; and
navigate the virtual three-dimensional space with the one or more actuators of the handheld controller.

2. The system of claim 1, wherein the one or more actuators comprise a left-thumb stick, a right-thumb stick, a left bumper, a right bumper, a left trigger, a right trigger, and a plurality of buttons.

3. The system of claim 2, wherein the three-dimensional modeling application comprises a building information management (BIM) application.

4. The system of claim 1, wherein the one or more modeling navigation commands comprise one or more of a simulated left-mouse click, a simulated right-mouse click, select multiple objects, clear object selection, display a current layout of the handheld controller, activate mouse, display a menu of properties associated with a selected object, display a selection tree indicating sub-drawings related to the drawing file, print a current screen, crawl, sprint, elevation up, elevation down, camera movement, invert speed control, invert y-axis, display properties, clear, or exit.

5. The system of claim 1, wherein the instructions, when executed, further cause the system to:
determine that the handheld controller is coupled to a controller port; and
present, at least partly in response to the second user input and the handheld controller being coupled to the controller port, a controller identifier indicating that the handheld controller is available for selection.

6. The system of claim 5, wherein the instructions, when executed, further cause the system to receive a selection of the controller identifier from a list of controller identifiers and, at least partly in response to the selection of the controller identifier, cause the handheld controller to vibrate.

7. The system of claim 1, wherein the instructions, when executed, further cause the system to save the layout associated with a layout identifier based on one or more layout identifier rules comprising:
prohibiting the layout identifier from comprising a ‘DefaultConfig’ string;
prohibiting a period punctuation mark in the layout identifier; or
including a .txt suffix in the layout identifier.

8. A method comprising:
receiving one or more user inputs at a graphical user interface (GUI) of a three-dimensional modeling application;
assigning, at least partly in response to the one or more user inputs, one or more modeling navigation commands to a one or more actuators of a handheld controller to create a layout for the handheld controller;
opening a drawing file with the three-dimensional modeling application to render a virtual three-dimensional space at the GUI;
receiving, at least partly in response to the one or more user inputs, a selection of the handheld controller for activation from a menu of the three-dimensional modeling application;
activating the handheld controller based at least partly on the selection; and
navigating the virtual three-dimensional space with the one or more actuators of the handheld controller based on the layout.

9. The method of claim 8, wherein the handheld controller comprises a standardized gaming console controller and the one or more actuators comprise at least one or more of a left-thumb stick, a right-thumb stick, a left bumper, a right bumper, a left trigger, a right trigger, or a plurality of buttons.

10. The method of claim 8, wherein the three-dimensional modeling application comprises a building information management (BIM) application.

11. The method of claim 8, wherein the one or more modeling navigation commands comprise one or more of a simulated left-mouse click, a simulated right-mouse click, select multiple objects, clear object selection, display a current layout of the handheld controller, activate mouse, display a menu of properties associated with a selected object, display a selection tree indicating sub-drawings related to the drawing file, print a current screen, crawl, sprint, elevation up, elevation down, camera movement, invert speed control, invert y-axis, display properties, clear, or exit.

12. The method of claim 8, further comprising:
determining that the handheld controller is coupled to a controller port; and
presenting, at least partly in response to second user input and the handheld controller being coupled to the controller port, a controller identifier indicating the handheld controller is available for selection.

13. The method of claim 12, further comprising receiving a selection of the controller identifier from a list of controller identifiers and, at least partly in response to the selection of the controller identifier, causing the handheld controller to vibrate.

14. The method of claim 8, further comprising saving the layout associated with a layout identifier based on one or more layout identifier rules comprising:
prohibiting the layout identifier from comprising a ‘DefaultConfig’ string;
prohibiting a period punctuation mark in the layout identifier; or
including a .txt suffix in the layout identifier.

15. A device comprising:
a display;
one or more processors; and
one or more non-transitory computer-readable media storing instructions that, when executed, cause the device to:
open a drawing file with a three-dimensional modeling application to render a virtual three-dimensional space;
receive, at a graphical user interface (GUI) presented at the display, a first user input selecting a drop down menu of the three-dimensional modeling application;
receive, at the GUI, a second user input selecting a handheld controller from a list of handheld controllers for activation from the drop down menu;
activate the handheld controller in response to the second user input; and
navigate the virtual three-dimensional space with the handheld controller and based on a layout of the handheld controller, the layout comprising one or more assignments of actuators of the handheld controller to modeling navigation commands.

16. The device of claim 15, wherein the handheld controller comprises a standardized gaming console controller and the one or more actuators comprise at least one or more of a left-thumb stick, a right-thumb stick, a left bumper, a right bumper, a left trigger, a right trigger, or a plurality of buttons.

17. The device of claim 15, wherein the three-dimensional modeling application comprises a building information management (BIM) application.

18. The device of claim 15, wherein the one or more modeling navigation commands comprise one or more of a simulated left-mouse click, a simulated right-mouse click, select multiple objects, clear object selection, display a current layout of the handheld controller, activate mouse, display a menu of properties associated with a selected object, display a selection tree indicating sub-drawings related to the drawing file, print a current screen, crawl, sprint, elevation up, elevation down, camera movement, invert speed control, invert y-axis, display properties, clear, or exit.

19. The device of claim 15, wherein the instructions, when executed, further cause the device to:
determine that the handheld controller is coupled to a controller port; and
present, at least partly in response to the second user input and the handheld controller being coupled to the controller port, a controller identifier indicating that the handheld controller is available for selection.

20. The device of claim 19, wherein the instructions, when executed, further cause the device to receive a selection of the controller identifier from a list of controller identifiers and, at least partly in response to the selection of the controller identifier, cause the handheld controller to vibrate.
